(19) United States
(12) Patent Application Publication
(10) Pub. No.: US 2013/0149442 A1
(43) Pub. Date: Jun. 13, 2013

(54) ANTI-WEAR FUNCTIONAL GRADED MATERIAL AND METHOD

(71) Applicant: NUOVO PIGNONE S.P.A., Florence (IT)

(72) Inventors: Vincenzo BRANCHETTI, Firenze (IT); Francesco BALSAMO, Firenze (IT)

(73) Assignee: NUOVO PIGNONE S.P.A., Florence (IT)

(21) Appl. No.: 13/710,783

(22) Filed: Dec. 11, 2012

(30) Foreign Application Priority Data
Dec. 12, 2011 (IT) C02011A000061

(51) Int. Cl. B05D 1/28

(52) U.S. Cl. CPC B05D 1/286
USPC 427/180; 118/200

(57) ABSTRACT

A system for component surface physical property enhancement is provided. The system comprises a component configured to receive a coating, and a mirror component configured to be removable, wherein the mirror component comprises at least one coated surface coated with the coating, and wherein the at least one coated surface substantially mirrors at least one surface of the component, wherein the coating is configured to enhance a surface physical property of the at least one surface of the component, and wherein the coating is transferred by hot isostatic pressing from the mirror component to the component.

### BACKGROUND OF THE INVENTION

The embodiments of the subject matter disclosed herein generally relate to wear protection.

In various systems, where parts touch, wear can occur. Wear is typically undesirable because it can reduce the lifetime of equipment, increase equipment downtime and increase cost. One example of a system in which parts wear is a gas turbine. Combustors are used in a gas turbine to deliver hot combustion gases to a first stage of a turbine. Each combustor used in the system typically includes a fuel injection system with one or more fuel nozzles and a combustion chamber. A typical combustion chamber may include a combustion liner, a transition piece which is connected to and extends between the combustion chamber and the first stage of the turbine, and a flow sleeve. A passage is created between the combustion liner and the flow sleeve which allows at least a portion of the compressor discharge air to be introduced into the combustion liner for mixing with the fuel injected into the system through the fuel nozzles and for cooling purposes. Additionally, the transition piece directs and delivers the hot combustion gases to the first stage of the turbine for power generation and expansion.

More specifically, a combustor and its associated transition piece are described with respect to FIG. 1. A combustor 2 for use in a gas turbine has a combustion chamber 4, which is inside of a combustion liner 6 which may be cylindrical in shape. Fuel enters the combustion chamber 4 via a nozzle(s) 12. The combustion liner 6 is surrounded by a substantially cylindrical flow sleeve 8. However, a radial gap exists between the combustion liner 6 and the cylindrical flow sleeve 8 which acts as an air flow passage to introduce air into the combustion chamber 4 to be mixed with the fuel delivered through the fuel nozzle 12. A transition piece 10 connects the combustion liner 6 with a first stage of a turbine (not shown).

During operation, some combustion parts are affected by wear induced by, for example, hardware vibrations. This wear generates maintenance and expense costs related to downtime and replacement parts. While gas turbine combustion parts are used here as an example, other parts used in other types of machinery can also experience wear. One potential method for reducing wear of parts is to spray a wear resistant coating on the surfaces of these parts. These spray coating mechanisms are performed with the spray nozzle at approximately a 90° angle to the desired coating surface. Some parts, such as corners and various curves, have geometries that do not always allow for the required spraying angle (between the coating spray nozzle and the part surface) to be achieved which can result in either a thin coating or possibly no coating at all.

Accordingly, systems and methods for reducing wear, increasing the lifetime of parts and reducing costs are desirable.

### BRIEF SUMMARY OF THE INVENTION

According to an embodiment of the present invention, there is provided a system for component surface physical property enhancement. The system comprises a component configured to receive a coating, and a mirror component configured to be removable, wherein the mirror component comprises at least one coated surface coated with the coating, wherein the at least one coated surface substantially mirrors at least one surface of the component, wherein the coating is configured to enhance a surface physical property of the at least one surface of the component, and the coating is transferred by hot isostatic pressing (HIP) from the mirror component to the component.

According to an embodiment of the present invention, there is provided a method for surface physical property enhancement of a component. The method comprises coating at least one surface of a mirror component, wherein the at least one surface of the mirror component substantially mirrors at least one surface of the component, transferring, by hot isostatic pressing, the coating from the mirror component to the component, and removing the mirror component. The coating is configured to enhance a surface physical property

According to an embodiment of the present invention, there is provided a system for component surface physical property enhancement. The system comprises a component configured to receive a coating, a mirror component configured to create a gap between the mirror component and the component, wherein the mirror component comprises at least one surface which substantially mirrors at least one surface of the component, and a coating powder disposed in the gap, wherein the coating powder is configured to enhance a surface physical property of the at least one surface of the component, wherein hot isostatic pressing is performed to apply the coating powder to the at least one surface of the component.

### BRIEF DESCRIPTION OF THE DRAWINGS

The accompanying drawings illustrate exemplary embodiments, wherein:

FIG. 1 depicts a traditional combustor and a transition piece;

FIG. 2 shows two parts in contact according to exemplary embodiments;

FIG. 3 illustrates an H-block attached to a flange according to exemplary embodiments;

FIG. 4 illustrates a fork according to exemplary embodiments;

FIG. 5 shows a combustor liner stop and its mating piece according to an exemplary embodiment;

FIG. 6 illustrates an H-shaped block according to exemplary embodiments;

FIG. 7 shows spraying an anti-wear coating on a mirror component according to exemplary embodiments;

FIG. 8 illustrates transferring an anti-wear coating from a mirror component to an H-shaped block according to exemplary embodiments;

FIG. 9 depicts removing the mirror component according to exemplary embodiments;

FIG. 10 shows an H-shaped block with an anti-wear coating according to exemplary embodiments;

FIG. 11 shows a wear component and a mirror component according to exemplary embodiments;

FIG. 12 illustrates a gap between a component and a mirror component according to exemplary embodiments;

FIG. 13 depicts filling a gap with a tungsten carbide powder according to exemplary embodiments; and

FIG. 14 is a flowchart illustrating a method for reducing wear according to exemplary embodiments.

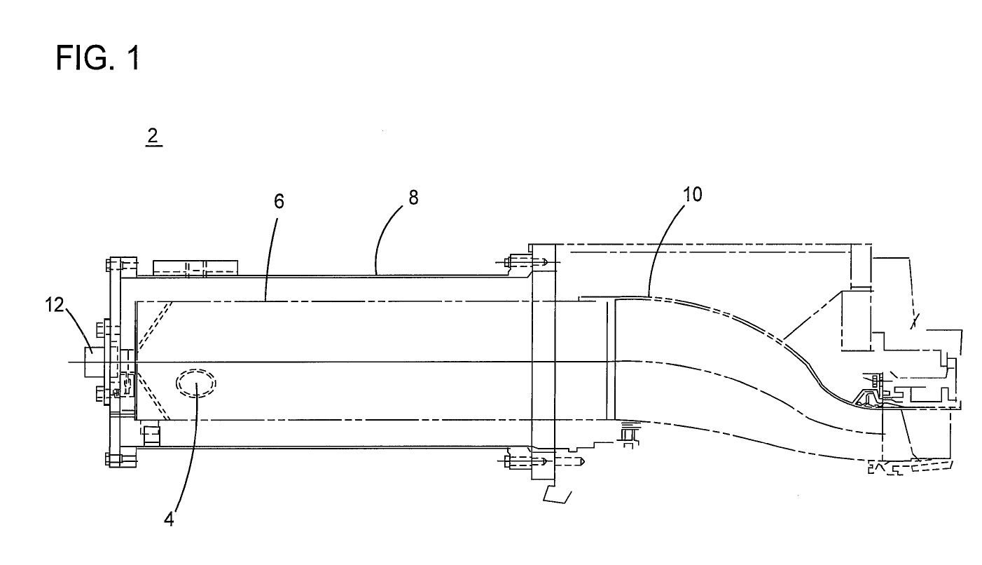

### DETAILED DESCRIPTION OF THE EXEMPLARY EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to exemplary embodiments, one or more surface physical properties on a part or component can be enhanced. Examples of surface physical properties enhancements include enhancements for components which may be used in wear environments, acidic environments, and corrosive environments and/or used as thermal barriers. These parts can have multiple surfaces and be used in various applications, for example, components in machinery, piping, connectors and the like.

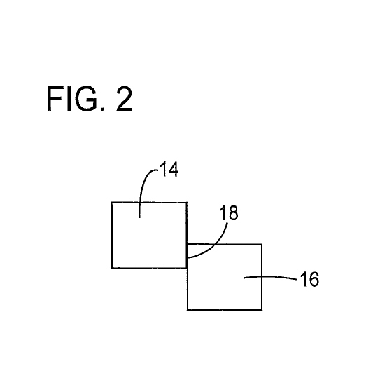

One example of a surface physical property which can be enhanced is wear reduction. According to an exemplary embodiment, an anti-wear coating can be applied to a surface or surfaces of a component which experience wear. The component can include at least one surface which experiences wear from, for example, physical contact from another part. This physical contact between the two parts can occur from a variety of mechanisms such as, friction, contact caused by a start/stop motion, vibration and the like. A component can be in any shape or size. Examples of wear surface geometries can include, but are not limited to, flat surfaces, shaped surfaces, interior surfaces, concave surfaces, convex surfaces, and other geometrically shaped surfaces. For example, any two mating components can experience wear under various circumstances. An example of two parts in contact with each other is shown in FIG. 2, wherein a first part 14 is in contact with a second part 16 and wear between the two parts occurs when a system in which they are disposed is under operation due to, for example, vibration of the first part 14 and the second part 16. The wear occurs on both parts on a shared contact surface 18.

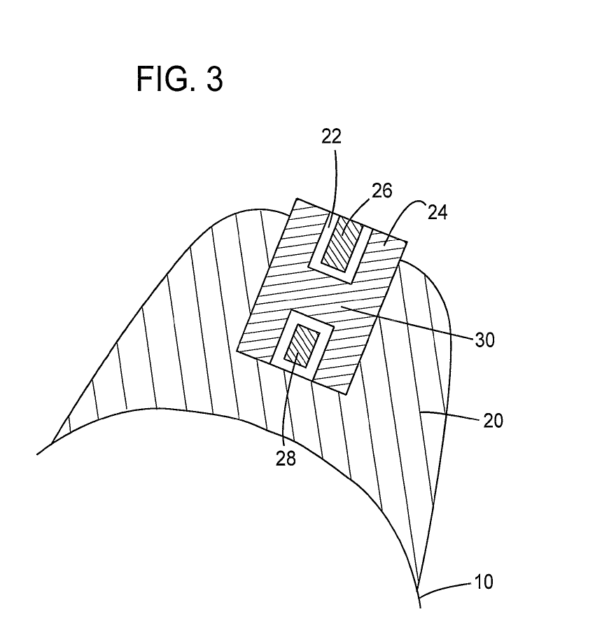

According to exemplary embodiments, the wear characteristics of contact points and surfaces associated with wear parts can be modified such that their useful lifetime is extended. Prior to discussing these exemplary embodiments, FIGS. 3-5 will be described to provide context with respect to the components which tend to wear in a gas turbine combustion system. While using a gas turbine combustion system as a nonexclusive illustrative example of a system in which parts wear, it is to be understood that other components in other systems can undergo wear. Various other parts, machinery and systems can benefit from the exemplary embodiments described herein.

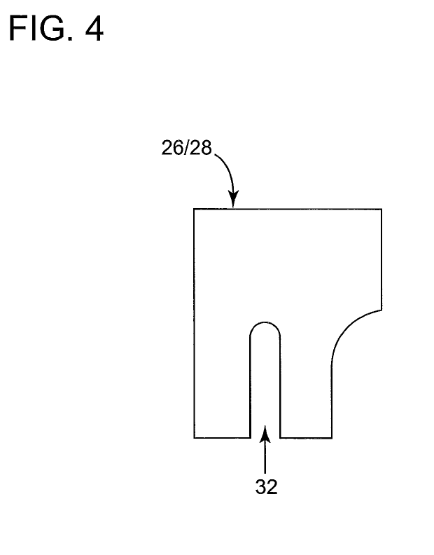

Initially, as seen in FIG. 3, a transition piece 10 can have a flanged section 20 which has an opening 22. Within the opening 22 and attached to the flanged section 20 is an H-shaped block (or substantially H-shaped block) 24. While FIG. 3 shows only a single H-shaped block 24 and a single flanged section 20, there may be two of these pieces/sections attached to the transition piece 10. Forks 26 and 28 are slidably received within the H-shaped block 24 such that the opposed facing surfaces of the finger elements can engage opposite sides of the cross piece 30 of the H-shaped block 24. Wear can occur on the interior surfaces of the H-shaped block 24 where the forks 26 and 28 could rub or vibrate. Wear can also occur on the facing surfaces of the forks 26 and 28 that contact the interior surfaces of the H-shaped block 24. According to exemplary embodiments, FIG. 4 also shows the forks 26 and 28 including the interior U-shaped surface 32 which also can have wear surfaces.

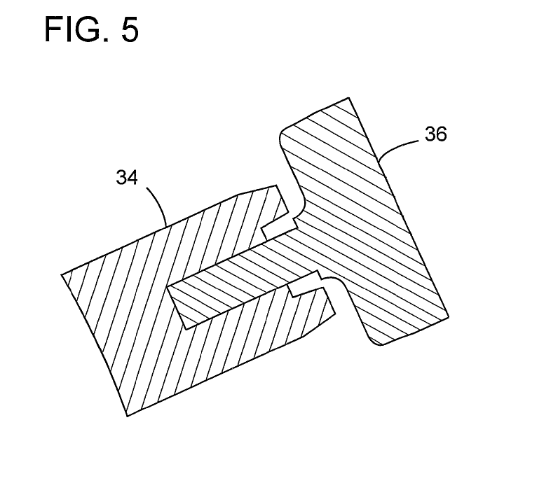

FIG. 5 shows a combustor liner stop 34 and a male mating piece 36, where these two pieces mate are also locations where wear can occur during operation of the combustor 2. Additionally, the H-shaped blocks 24, the combustor liner stops 34 and their respective mating pieces can be made from a Cobalt based super alloy, e.g., L-605, Hastelloy X or other so-called “super alloy”.

When in operation some of the various wear components can have a relatively short life time which can result in a higher than desired frequency of inspection and replacement. According to exemplary embodiments, the application of an anti-wear coating can increase the wear resistance of the various wear components, thus reducing the frequency of inspection and replacement of various wear components. Considerations for the amount of anti-wear coating to be used include, but are not limited to, brittleness, ductility and hardness. Various alloying elements can be introduced to an anti-wear coating in order to obtain the desired properties for the appropriate conditions.

According to exemplary embodiments, an anti-wear coating can be sprayed onto an mirror component, for example, a low carbon steel insert, for application to a wear surface which cannot be appropriately coated by direct spraying means. The geometry of a so-called “mirror component” generally mirrors the geometry of a surface or surfaces of a component to which the coating will be transferred. The thickness of the anti-wear coating sprayed on the mirror component can vary based upon such factors as coating material, desired thickness of transferred coating and expected transfer properties based on the temperature and pressure used during the transfer, as well as the diffusion properties of the material used in manufacturing the wear part. The tungsten carbide layer can be transferred from the mirror component to one or more wear surfaces of a part through a hot isostatic pressing (HIP) process.

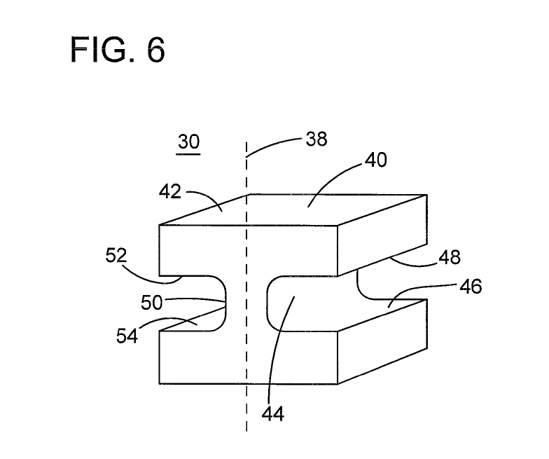

According to exemplary embodiments, an example of a component which can benefit from a coating is the H-shaped block 30 which can be machined to a shape as shown in FIG. 6. The H-shaped block 30 can include an overstock amount, which in an embodiment can be about 2 mm. The H-shaped block 30 has three wear surfaces on the interior of each “half”, with the halves of the H-shaped block 30 being split by dashed line 38. The first half 40 of the H-shaped block 30 has interior wear surfaces 44, 46 and 48. The second half 42 of the H-shaped block 30 has three interior wear surfaces 50, 52 and 54. The wear surfaces can be the interior surfaces to the H-shaped block 30 and can be described as a first surface 46 substantially perpendicular to a second surface 44 which is substantially perpendicular to a third surface 48, the third surface 48 being substantially parallel to and having a substantially same surface area as the first surface 46.

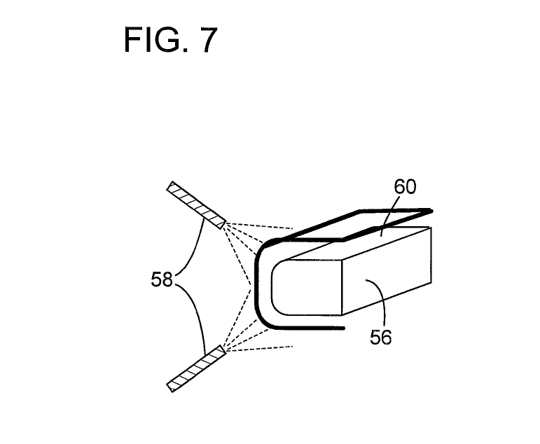

As described above, an anti-wear coating can be sprayed onto a wear surface. According to exemplary embodiments, the anti-wear coating can be applied by high velocity oxygen fuel (HVOF) spraying or plasma spraying via nozzles 58 onto an insert 56 as shown in FIG. 7. The geometry of the mirror component 56 generally mirrors the geometry of the wear surface to be coated, in this instance, the wear surfaces 44, 46 and 48 of the H-shaped block 30.

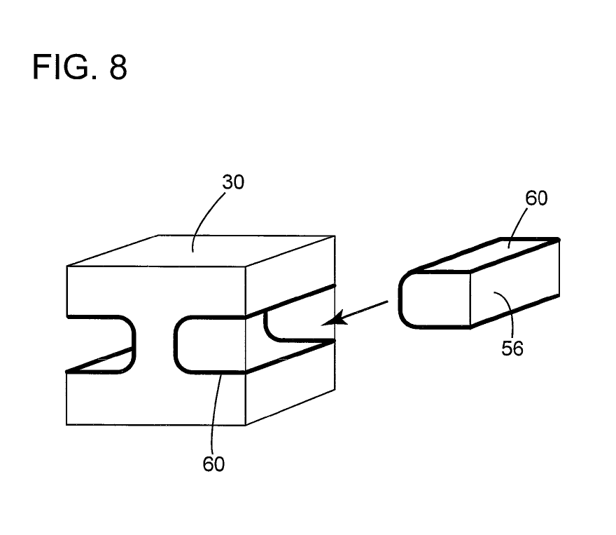

According to exemplary embodiments, the tungsten carbide coating 60 can then be transferred to the wear surfaces 44, 46 and 48 of the H-shaped block 30 by the HIP process as shown in FIG. 8. The HIP process can be performed at approximately 1200° C. and 100 MPa, however alternative temperatures and pressures can be used to ensure the desired diffusion of the tungsten carbide coating 60 into the H-shaped block 30 occurs. Additionally, while not shown, this operation can be performed for both sides 40 and 42 of the H-shaped block 30. Additionally, for different components, composition of the components and different compositions of the anti-wear coating (or other type of coating), various temperatures and pressures can be used for the HIP process.

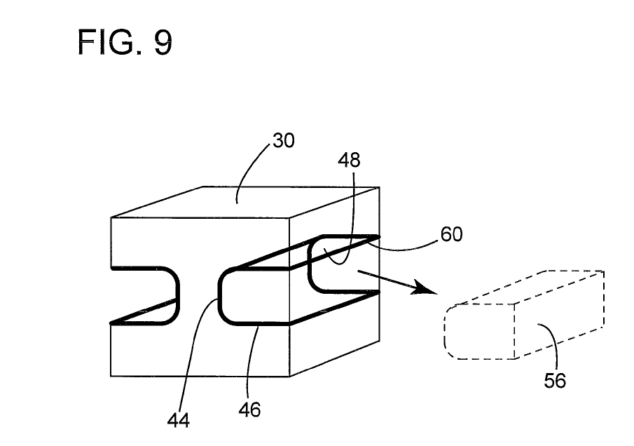

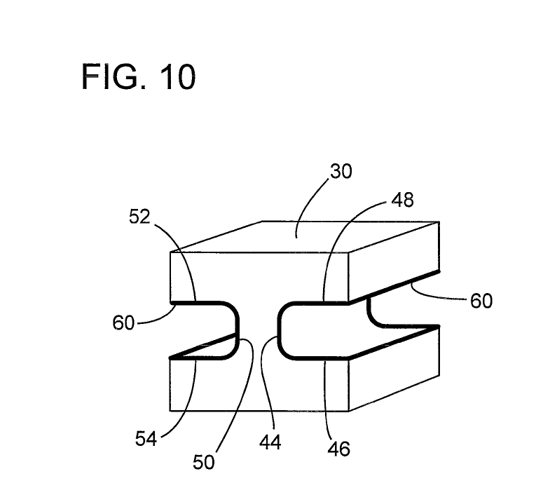

According to exemplary embodiments, as shown in FIG. 9, the mirror component 56 can be removed by acid leaching (or etching) and/or by machining and/or other processes. The dotted lines around the mirror component 56 indicate the removal of the mirror component 56 from the H-shaped block 30. Additionally, the presence of the tungsten carbide coating 60 on the wear surfaces 44, 46 and 48 of the H-shaped block 30 indicate that those surfaces are covered by the tungsten carbide coating 60 which has diffused as desired into the H-shaped block 30. After the acid leaching, overstock, for example, approximately 2 mm of material from the unprotected and/or uncoated surfaces, altered by the acid leaching can be removed by machining. The H-shaped block 30 can then be machined to its final dimensions as desired. A completed H-shaped block 30 is shown in FIG. 10 and includes all interior wear surfaces 44-54 having the tungsten carbide coating. Similar methods, as described above, can be used to transfer the anti-wear coating from a mirror component to one or more wear surfaces of the forks 26, 28, as well as on the wear surface 32 of the combustor liner stops 26, 28. The tungsten carbide coating 60 is to be considered an example of a coating, however other coatings which provide a desirable enhancement to surface physical property can be used as desired based upon, for example, the environment in which the parts are used.

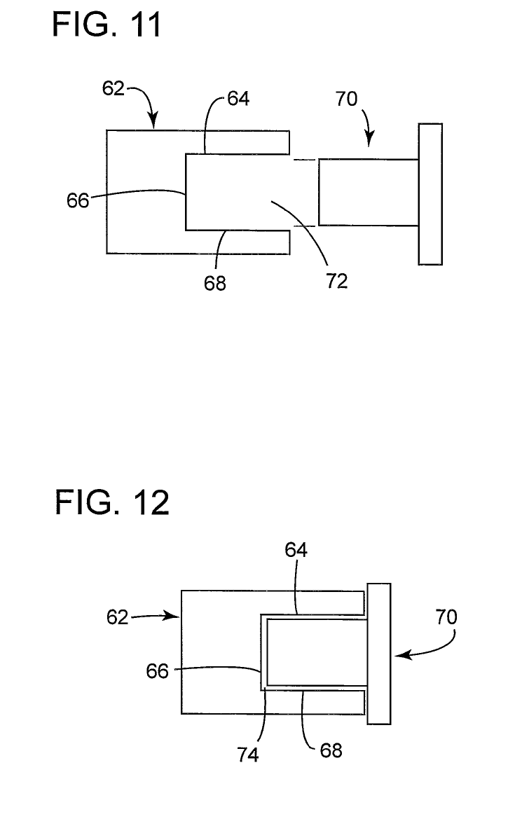

According to exemplary embodiments, another method of applying a coating to a surface of a part can be performed as will now be described with respect to FIGS. 11-13. This coating can be an anti-wear coating or a coating associated with another surface physical property enhancement. FIG. 11 shows a component 62 with three interior surfaces 64, 66, 68. Also shown is a mirror component 70 which can be made of a low carbon steel or other material as desired. The mirror component 70 generally mirrors the three interior surfaces 64, 66, 68 and the mirror component 70 is placed into the opening 72 of the component 62 as shown in FIG. 12. According to exemplary embodiments, there can be a gap between the three interior surfaces 64, 66, 68 and the mirror component 70. The size of the gap 74 can be controlled by sizing the mirror component 70 as desired. Additionally, the size of the gap 74 can be verified by various measurement means as desired. This gap 74 can be filled with a powder which can provide wear resistance, or other surface physical property enhancements, to the three interior surfaces 64, 66, 68.

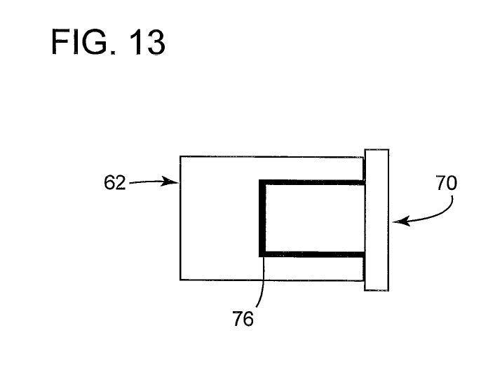

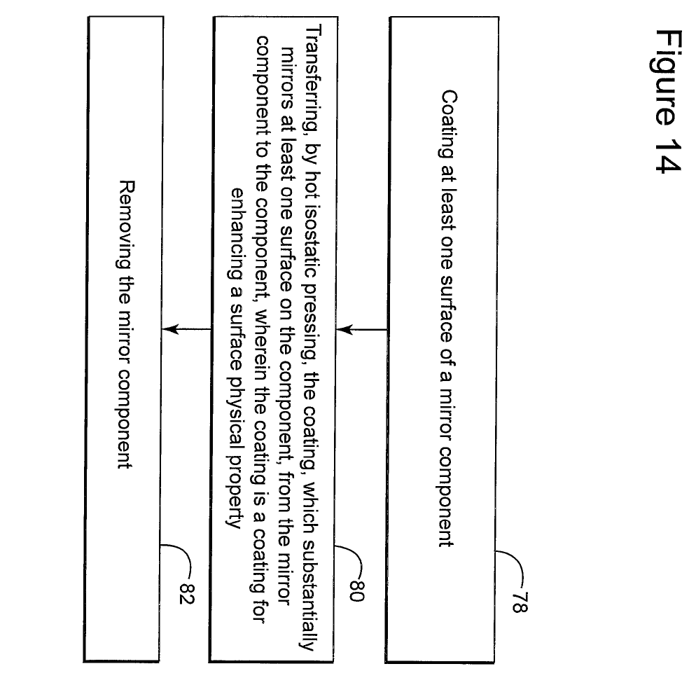

According to exemplary embodiments, as shown in FIG. 13, the gap 74 can be filled with a WC powder 76. Hot isostatic pressing can then be performed to render the WC powder 76 into a coating on the three internal surfaces 64, 66, 68 of the component 62. According to exemplary embodiments, acid leaching can then be used to remove the mirror component 70 followed by a final machining of the component 62 to achieve desired final dimensions and/or to remove overstock that was damaged by the acid leaching process. According to an exemplary embodiment, the mirror component can be made from two or more pieces, of which some may be mechanically removed. This can be done to reduce the amount of acid leaching and final machining to be performed and may be desirable based on the shape of the mirror component 70.

According to exemplary embodiments, as described above, a coating can be sprayed onto a metal mirror component or applied as a powder prior to undergoing the HIP process. The coating can be tungsten carbide. Alternatively, various other elements and alloys can also be used as anti-wear coating as desired. For example cobalt and/or chromium could be added to the tungsten carbide to achieve the desired characteristics of the coating. According to an exemplary embodiment an inclusive composition range of tungsten carbide with cobalt can be from about 83% tungsten carbide and about 17% cobalt to about 91% tungsten carbide and about 9% cobalt. Alternatively, chromium could be added, for example, about 4% chromium, while adjusting the tungsten carbide and/or cobalt percentages accordingly. It is to be understood that these composition ranges are not to be considered limiting and that other composition ranges (and/or materials) could be used to obtain the desired characteristics in the anti-wear coating. Additionally, other coatings which provide the desired mechanical/material properties and can be applied via HVOF and/or thermal spraying technologies can be used. According to an exemplary embodiment, the thickness of the coating can be of a substantially uniform thickness on the surface(s). According to an exemplary embodiment, a variable thickness of the coating can be used.

As described above, mirror components can be shaped which substantially mirror other surfaces (or portions of the surface) where direct spraying of HVOF and/or plasma may not be desirable or even performable. According to exemplary embodiments, other shapes then previously described can benefit from the exemplary systems and methods disclosed herein. For example, other surfaces which may be flat, may be curved, may be concave (or even closed like an inner surface of a pipe), or may be other desired geometrical shapes, can have coatings applied to them using these exemplary methods and systems.

Utilizing the above-described exemplary systems according to exemplary embodiments, a method for surface physical property enhancement is shown in the flowchart of FIG. 14. A method for surface physical property enhancement of at least one component includes: coating 78 at least one surface of a mirror component; transferring 80, by hot isostatic pressing, the coating, which substantially mirrors at least one surface on the component, from the mirror component to the component, wherein the coating is a coating for enhancing a surface physical property; and removing 82 the mirror component.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A system for component surface physical property enhancement, the system comprising:
a component configured to receive a coating; and
a mirror component configured to be removable, wherein the mirror component comprises at least one coated surface coated with the coating, and wherein the at least one coated surface substantially mirrors at least one surface of the component,
wherein the coating is configured to enhance a surface physical property of the at least one surface of the component, and wherein the coating is transferred by hot isostatic pressing from the mirror component to the component.

2. The system of claim 1, wherein the coating is an anti-wear coating.

3. The system of claim 2, wherein the anti-wear coating is a tungsten carbide coating.

4. The system of claim 1, wherein the component is a substantially H-shaped block configured to secure a transition piece of a gas turbine combustor to a support piece, wherein the at least one surface of the component comprises a first surface substantially perpendicular to a second surface which is substantially perpendicular to a third surface, and wherein the third surface is substantially parallel to and has a substantially same surface area as the first surface.

5. A method for surface physical property enhancement of a component, the method comprising:
coating at least one surface of a mirror component, wherein the at least one surface of the mirror component substantially mirrors at least one surface of the component;
transferring, by hot isostatic pressing, the coating from the mirror component to the component, wherein the coating is configured to enhance a surface physical property; and
removing the mirror component.

6. The method of claim 5, wherein the coating is an anti-wear coating.

7. The method of claim 6, wherein the coating is a tungsten carbide coating.

8. The method of claim 5, wherein the component is a substantially H-shaped block configured to secure a transition piece of a gas turbine combustor to a support piece, wherein the at least one surface of the component comprises a first surface substantially perpendicular to a second surface which is substantially perpendicular to a third surface, and wherein the third surface is substantially parallel to and has a substantially same surface area as the first surface.

9. A system for component surface physical property enhancement, the system comprising:
a component configured to receive a coating;
a mirror component configured to create a gap between the mirror component and the component, wherein the mirror component comprises at least one surface which substantially mirrors at least one surface of the component; and
a coating powder disposed in the gap, wherein the coating powder is configured to enhance a surface physical property of the at least one surface of the component, wherein hot isostatic pressing is performed to apply the coating powder to the at least one surface of the component.

10. The system of claim 9, wherein the component is a substantially H-shaped block configured to secure a transition piece of a gas turbine combustor to a support piece, wherein the at least one surface of the component comprises a first surface substantially perpendicular to a second surface which is substantially perpendicular to a third surface, and wherein the third surface is substantially parallel to and has a substantially same surface area as the first surface.
